(19) United States
(12) Patent Application Publication
(10) Pub. No.: US 2021/0110402 A1
(43) Pub. Date: Apr. 15, 2021

(54) WARRANTY GRADE

(71) Applicant: HEWLETT-PACKARD DEVELOPMENT COMPANY, L.P., Spring, TX (US)

(72) Inventors: Nailson Boaz Costa Leite, Porto Alegre (BR); Ricardo Farias Piccoli, Porto Alegre (BR)

(21) Appl. No.: 16/604,112

(22) PCT Filed: Nov. 10, 2017
(86) PCT No.: PCT/US2017/061000

§ 371 Date: Oct. 9, 2019

(51) Int. Cl. G06Q 30/00; H04L 29/08; G16Y 40/10; G16Y 40/20

(52) U.S. Cl. CPC G06Q 30/012; G16Y 40/20; G16Y 40/10; H04L 67/125

(57) ABSTRACT

Examples disclosed herein relate to receiving an event notification associated with a product device, modifying a warranty grade associated with the product device according to the event notification, determining whether the modified warranty grade is below a minimum threshold, and in response to determining that the modified warranty grade is below a minimum threshold, discontinuing a warranty for the product device

### BACKGROUND

Devices, such as printers, laptops, computers, smart phones, etc. are often sold to different businesses and customers. These devices are exposed to a variety of environments and levels of care that can affect the operation of those devices. Additionally, these devices may be provided with a warranty that covers repairs and/or support for low or no cost.

### BRIEF DESCRIPTION OF THE DRAWINGS

In the accompanying drawings, like numerals refer to like components or blocks. The following detailed description references the drawings, wherein:

FIG. 1 is a block diagram of an example computing device for providing a warranty grade;

FIG. 2 is an example timeline visualization for a warranty grade;

FIG. 3 is a flowchart of an example of a method for providing a warranty grade; and

FIG. 4 is an example system for providing a warranty grade.

### DETAILED DESCRIPTION

Warranties are often offered by manufacturers and retailers of various devices, such as computers, printers, laptops, tablets, phones, etc. These warranties generally offer free and/or discounted repair and/or support service for trouble issues, such as technical difficulty, defects, accidental damage, etc.

Warranty claims represent a significant expense for device manufacturers and retailers. Repair and support claims made under the terms of a warranty need to be assessed for validity and compliance with the warranty terms even before a response is provided. In some situations, the devices are subject to accidental and/or intentional misuse that causes damage not meant to be covered by the warranty. These occurrences may be difficult to differentiate from valid warranty claims, however.

Even where misuse of the product occurs, companies do not want to irritate their customers, so providing coverage for otherwise invalid warranty claims is sometimes an acceptable expense. Keeping these expenses under control is a difficult challenge—some repeat offenders take advantage of warranty programs while other customers may be denied warranty coverage after a single misuse incident voids the terms of the warranty. In many typical warranties, different events that may be categorized as abuse and/or misuse may have different levels of severity in terms of their actual effect on the device, but the warranty terms are often voided regardless of this severity after a single incident. This can be aggravating to a customer who may not even realize that misuse occurred, such as where an operating environment temperature exceeded a given threshold. Furthermore, warranty terms are often confusing to consumers and may differ significantly from product to product.

These issues may be alleviated by tracking various misuse events, such as operating temperature, humidity, liquid exposure, drops, bumps, and/or shocks, unusual electrical conditions. These events may be measured by sensors associated with the device directly (e.g., a built-in accelerometer) and/or may be gathered by environmental sensors associated with a user, such as a heating/air-conditioning system thermostat that provides ambient temperature readings in a location associated with the device.

Such misuse events may be logged to a user's account and tracked against the terms of a device's warranty requirements. Instead of voiding the warranty after a single misuse event, a declining grade may be applied to the device's warranty. This grade, and a history of the misuse events, may be made available to the user, such as on a display of the device and/or via an account website, for example. The current grade of the device's warranty may also be displayed, as well as any effect the current grade has on the warranty coverage.

For example, a printer may be located in an office environment that routinely exceeds an operating temperature threshold. A warranty grade may start at 100 and be decremented 5 points for every hour the temperature is above that operating threshold. A timeline visualization may be made available for display to the user showing the time, date, duration, and temperature measurement for each of these misuse events. The visualization may also show the history of the changes to the warranty grade for each of these misuse events. Once the grade drops below a certain threshold, the warranty coverage may change, such as by declining to offer support entirely and/or offering support at an increased cost.

In some situations, the declining grade may be presented to the user as a reason to purchase a warranty plan with different coverage terms that take the history of misuse events into account. For example, a user with a history of drop events for their phone, as measured by an internal accelerometer, may be encouraged to purchase additional breakage repair coverage rather than waiting until a warranty claim is requested and denied.

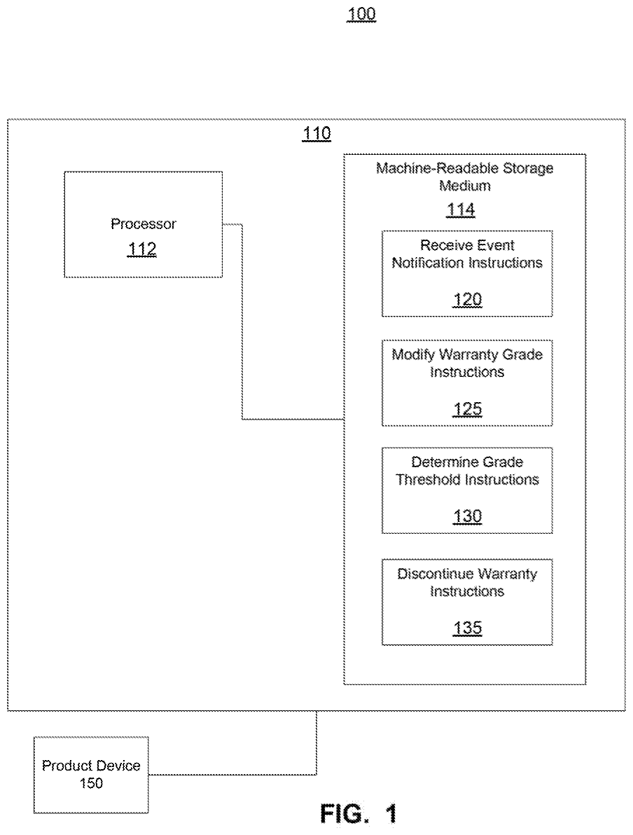

FIG. 1 is a block diagram of an example computing device 110 for providing a warranty grade. Computing device 110 may comprise a processor 112 and a non-transitory, machine-readable storage medium 114. Storage medium 114 may comprise a plurality of processor-executable instructions, such as receive event notification instructions 120, modify warranty grade instructions 125, determine grade threshold instructions 130, and discontinue warranty instructions 135. In some implementations, instructions 120, 125, 130, 135 may be associated with a single computing device 110 and/or may be communicatively coupled among different computing devices such as via a direct connection, bus, or network.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 125, 130, 135.

Executable instructions 120, 125, 130, 135 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Receive event notification instructions 120 may receive an event notification associated with a product device 150. Product device 150 may comprise, for example, a consumer device such as a computer, laptop, phone, tablet, gaming console, or similar electronic device. Such consumer devices may be covered by a warranty, often issued by a manufacturer or retailer, to provide free and/or reduced cost support and/or service.

In some implementations, the event notification comprises an event type and a severity level. Event types may comprise different classifications of occurrences detected by sensors associated with the product device 150. Event notifications may identify a type of sensor used to detect the event as well as which type of event occurred. Sensors may comprise any component, whether coupled to the device or not, that provides information about the conditions obtaining in and/or around the product device. Sensors may comprise, for example, a humidity sensor, a temperature sensor, a gyroscope, a shock sensor, a voltage sensor, a global positioning system, and a current sensor

Event notifications may be associated with misuse events, such as occurrences that may cause damage to the product device 150. Any number of misuse event types may be defined, such as operating temperature, bump, shock, impact, electrical conditions (e.g. current and/or voltage), humidity, moisture exposure, incorrect part and/or supply installation, etc. Additionally a warranty grade penalty may be associated with each misuse type. Not all event notifications may be associated with a misuse event. A misuse event may be considered an event that results in a reduction in the warranty grade associated with the product device 150.

Severity levels may also be provided in the event notification and may affect a resulting change in warranty grade. For example, sensor values may be sorted into “normal”, “low severity”, “medium severity”, and/or “high severity”. The low/medium/high designation may be assigned based on an amount of deviation from a normal sensor reading. As one illustration, a “normal” operating temperature may be considered to be a range of 60-85 degrees Fahrenheit. A sensor reading of 85-90 degrees Fahrenheit may be considered a “low” severity misuse event, a reading of 90-100 degrees Fahrenheit may be considered a “medium” severity misuse event, and readings over 100 degrees Fahrenheit may be considered a “high” severity misuse event. These ranges may be adjusted for any product device, and are presented only as an example.

Modify warranty grade instructions 125 may modify a warranty grade associated with the product device according to the event notification. For example, the warranty grade may be modified by an amount associated with the event type (e.g., a “drop” type misuse event.) Warranty grades may use a scale defined by the warranty issuer (e.g., the manufacturer of product device 150.) For example purposes, a warranty grade may begin at 100 and have grade deductions applied for each misuse event. For example, an operating environment temperature exceeding a safe temperature threshold may result in a −5 penalty to a warranty grade while a drop event, measured by an accelerometer in product device 150, may result in a −15 penalty to the warranty grade.

In some implementations, modify warranty grade instructions 125 may modify the warranty grade by an amount associated with the severity level. For example, a low severity misuse event may result in a −5 decrease to the warranty grade, a medium severity misuse event may result in a −10 decrease to the warranty grade, and a high severity misuse event may result in a −15 decrease to the warranty grade.

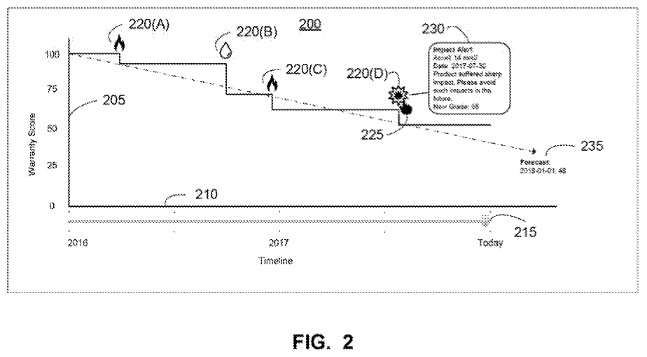

In some implementations, the user may be notified of the modified warranty grade after an event notification is received. For example, the user may receive an email or other notification and/or a message may be displayed on product device 150. In some implementations, the notification to the user may comprise a timeline visualization identifying a time the event notification associated with the device was received. An example timeline visualization is discussed below in greater detail with respect to FIG. 2. Such a timeline visualization may indicate each time an event notification associated with the device was received, and may show misuse events and/or non-misuse events.

Determine grade threshold instructions 130 may determine whether the modified warranty grade is below a minimum threshold. The warrantor may set a minimum threshold for the warranty grade, below which the warranty may be considered void. The threshold may be assigned based on the product device 150, options purchased for the product device 150, any warranty extensions selected for product device 150, and/or characteristics associated with the user. For example, a repeat customer may be given a lower threshold than a first-time customer. Such a threshold may be established based on the repeat customer's known history of misuse events and/or may be offered as a loyalty reward. In some implementations, the warranty may remain valid and not discontinued until the warranty grade is fully depleted, such as where a starting grade of 100 is reduced to or below 0.

Discontinue warranty instructions 135 may, in response to determining that the modified warranty grade is below a minimum threshold, discontinue a warranty for the device. For example, a minimum threshold for a user's printer device may be set at 25. After a series of misuse events lower the grade to 20, the warranty may be discontinued and no further services may be provided under the warranty.

In some implementations, the user may be notified of the modified warranty grade after an event notification is received and/or notified that the warranty has been discontinued. For example, the user may receive an email or other notification and/or a message may be displayed on product device 150.

FIG. 2 is an example timeline visualization 200 for a warranty grade. Visualization 200 may comprise a graph comprising a y-axis 205 representing the warranty grade and an x-axis 210 representing a continuous timeline. A slider control 215 may allow a user to select different periods along the timeline of x-axis 210 by sliding the control 215 back and forth. Visualization 200 may further comprise a plurality of event indicators 220(A)-(D). Each event indicator 220(A)-(D) may represent a detected misuse event associated with a user's device. Each misuse event may, for example, be associated with a decrease in the device's warranty grade. By hovering a pointer 225 over one of event indicators 220(A)-(D), such as indicator 220(D) in the illustrated example, an information tooltip 230 may be displayed to provide additional information about the misuse event. Such information may include the event type, sensor readings associated with the event, the time the event occurred, and/or information about the effect of the event on the warranty grade. In some implementations, visualization 200 may include additional analysis data, such as a forecast 235 of the future warranty grade based on past event occurrences and times.

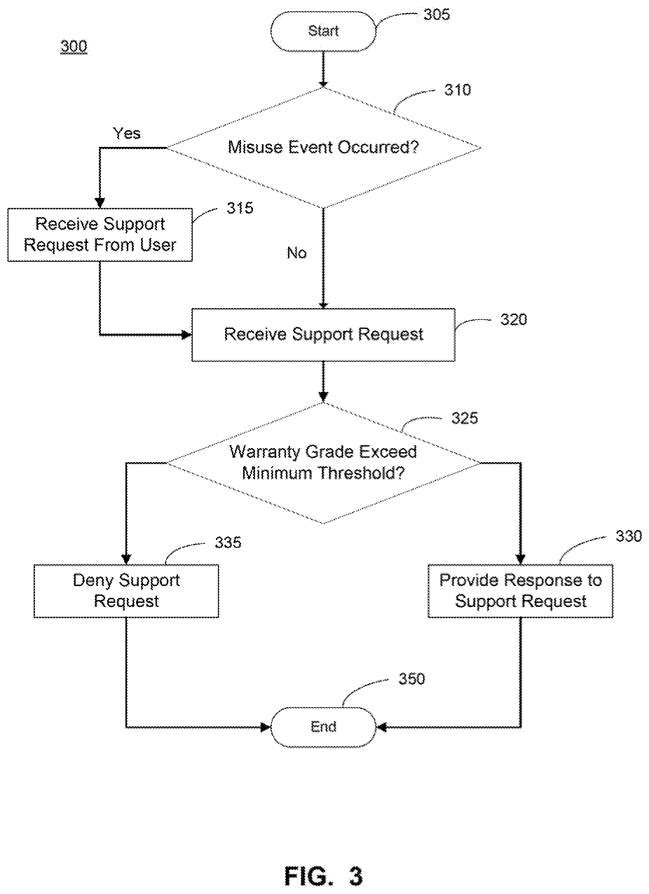

FIG. 3 is a flowchart of an example method 300 for providing a warranty grade. Although execution of method 300 is described below with reference to computing device 110, other suitable components for execution of method 300 may be used.

Method 300 may begin at stage 305 and advance to stage 310 where computing device 110 may determine whether a misuse event has occurred with respect to the device. A misuse event, for example, may comprise a detection, by a sensor associated with the device, of an event not in compliance with a requirement of the warranty. For example, sensors may comprise temperature, humidity, and/or electrical sensors. Other sensors may comprise accelerometers and/or location sensors (e.g., GPS). In some implementations, sensors not directly connected to the device may provide information for a misuse event associated with the device, such as a thermostat reporting a room temperature for a room in which the device is located.

In some implementations, computing device 100 may execute receive event notification instructions 120 to receive an event notification associated with a product device 150. Product device 150 may comprise, for example, a consumer device such as a computer, laptop, phone, tablet, gaming console, or similar electronic device. Such consumer devices may be covered by a warranty, often issued by a manufacturer or retailer, to provide free and/or reduced cost support and/or service.

In some implementations, the event notification comprises an event type and a severity level. Event types may comprise different classifications of occurrences detected by sensors associated with the product device 150. Event notifications may identify a type of sensor used to detect the event as well as which type of event occurred. Sensors may comprise any component, whether coupled to the device or not, that provides information about the conditions obtaining in and/or around the product device. Sensors may comprise, for example, a humidity sensor, a temperature sensor, a gyroscope, a shock sensor, a voltage sensor, a global positioning system, and a current sensor

Event notifications may be associated with misuse events, such as occurrences that may cause damage to the product device 150. Any number of misuse event types may be defined, such as operating temperature, bump, shock, impact, electrical conditions (e.g. current and/or voltage), humidity, moisture exposure, incorrect part and/or supply installation, etc. Additionally a warranty grade penalty may be associated with each misuse type. Not all event notifications may be associated with a misuse event. A misuse event may be considered an event that results in a reduction in the warranty grade associated with the product device 150.

Severity levels may also be provided in the event notification and may affect a resulting change in warranty grade. For example, sensor values may be sorted into “normal”, “low severity”, “medium severity”, and/or “high severity”. The low/medium/high designation may be assigned based on an amount of deviation from a normal sensor reading. As one illustration, a “normal” operating temperature may be considered to be a range of 60-85 degrees Fahrenheit. A sensor reading of 85-90 degrees Fahrenheit may be considered a “low” severity misuse event, a reading of 90-100 degrees Fahrenheit may be considered a “medium” severity misuse event, and readings over 100 degrees Fahrenheit may be considered a “high” severity misuse event. These ranges may be adjusted for any product device, and are presented only as an example.

In response to determining that the misuse event has occurred with respect to the device, method 300 may advance to stage 315 where computing device 110 may reduce a warranty grade of the device. For example, computing device 110 may execute modify warranty grade instructions 125 to modify a warranty grade associated with the product device according to the event notification. For example, the warranty grade may be modified by an amount associated with the event type (e.g., a “drop” type misuse event.) Warranty grades may use a scale defined by the warranty issuer (e.g., the manufacturer of product device 150.) For example purposes, a warranty grade may begin at 100 and have grade deductions applied for each misuse event. For example, an operating environment temperature exceeding a safe temperature threshold may result in a −5 penalty to a warranty grade while a drop event, measured by an accelerometer in product device 150, may result in a −15 penalty to the warranty grade.

In some implementations, modify warranty grade instructions 125 may modify the warranty grade by an amount associated with the severity level. For example, a low severity misuse event may result in a −5 decrease to the warranty grade, a medium severity misuse event may result in a −10 decrease to the warranty grade, and a high severity misuse event may result in a −15 decrease to the warranty grade.

In some implementations, the user may be notified of the modified warranty grade after an event notification is received. For example, the user may receive an email or other notification and/or a message may be displayed on product device 150. In some implementations, the notification to the user may comprise a timeline visualization identifying a time the event notification associated with the device was received. An example timeline visualization is discussed below in greater detail with respect to FIG. 2. Such a timeline visualization may indicate each time an event notification associated with the device was received, and may show misuse events and/or non-misuse events.

Method 300 may then advance to stage 320 where computing device 110 may receive a support request for a device. For example, a user of product device 150 may request a repair to product device 150 and/or request technical support for using product device 150. Such requests may be submitted, for example, electronically, in-person, and/or via telephone.

Method 300 may then advance to stage 325 where computing device 110 may determine whether the warranty grade exceeds a minimum threshold. For example, computing device 110 may execute determine grade threshold instructions 130 to determine whether the modified warranty grade is below a minimum threshold. The warrantor may set a minimum threshold for the warranty grade, below which the warranty may be considered void. The threshold may be assigned based on the product device 150, options purchased for the product device 150, any warranty extensions selected for product device 150, and/or characteristics associated with the user. For example, a repeat customer may be given a lower threshold than a first-time customer. Such a threshold may be established based on the repeat customer's known history of misuse events and/or may be offered as a loyalty reward. In some implementations, the warranty may remain valid and not discontinued until the warranty grade is fully depleted, such as where a starting grade of 100 is reduced to or below 0.

In response to determining that the warranty grade exceeds the minimum threshold, method 300 may advance to stage 330 where computing device 110 may provide a response to the support request in accordance with the warranty. For example, a repair technician may be dispatched, technical support may be provided, and/or a return authorization for product device 150 may be issued, depending on the nature of the support request.

In response to determining that the warranty grade does not exceed the minimum threshold, method 300 may advance to stage 335 where computing device 110 may deny the support request. In some implementations, computing device 110 may also provide an option for the user to purchase a support extension to the warranty. For example, a device needing repair may have been the subject of enough misuse events to drop the warranty grade below the minimum threshold, thus voiding the warrantor's obligation to provide service. The user may then be given an option to purchase additional warranty coverage in order to receive the support and/or repairs requested. This additional coverage may take past misuse events and trends into account for the cost and covered services. For example, a user whose device's warranty grade declines at 10 points per year may be offered an extended warranty coverage plan for a lower cost than a user whose device's warranty grade declines at 25 points per year.

In some implementations, a user's warranty grade trend may be extrapolated from a plurality of devices. For example, a user who owns three printers may have their average warranty grade and trends calculated before determining the appropriate price for the extended warranty coverage.

Method 300 may then end at stage 350.

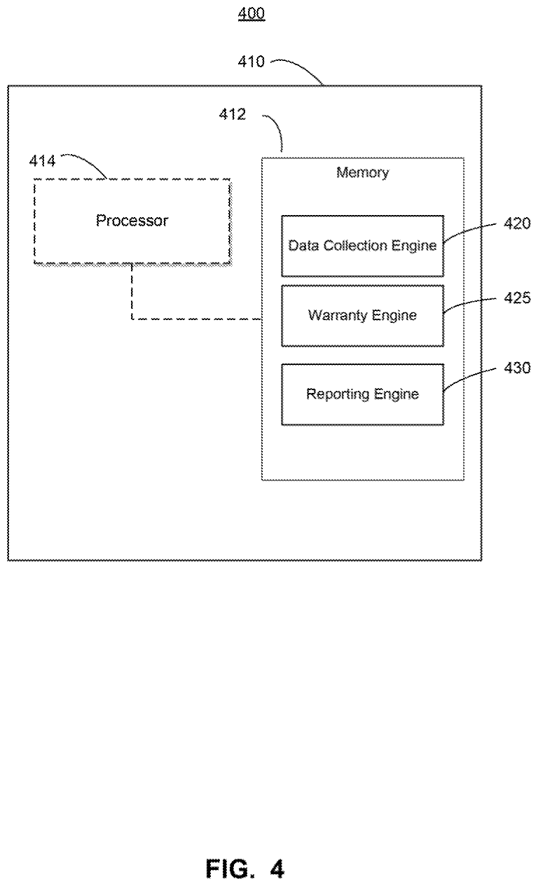

FIG. 4 is a block diagram of an example system 400 for providing a warranty grade. System 400 may comprise a computing device 410 comprising a memory 412 and a processor 414. Computing device 410 may comprise, for example, a general and/or special purpose computer, server, mainframe, desktop, laptop, tablet, smart phone, game console, printer and/or any other system capable of providing computing capability consistent with providing the implementations described herein. Computing device 410 may store, in memory 412, a data collection engine 420, a warranty engine 425, and a reporting engine 430.

Each of engines 420, 425, 430 of system 400 may comprise a combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 420, 425, 430. In such examples, computing device 110 may comprise the machine-readable storage medium storing the instructions and the processing resource to execute the instructions, or the machine-readable storage medium may be separate but accessible to system 300 and the processing resource.

Data collection engine 420 may collect data from a plurality of sensors associated with a device and determine whether the data indicates a misuse event. For example, data collection engine 420 may execute receive event notification instructions 120 may receive an event notification associated with a product device 150. Product device 150 may comprise, for example, a consumer device such as a computer, laptop, phone, tablet, gaming console, or similar electronic device. Such consumer devices may be covered by a warranty, often issued by a manufacturer or retailer, to provide free and/or reduced cost support and/or service.

In some implementations, the event notification comprises an event type and a severity level. Event types may comprise different classifications of occurrences detected by sensors associated with the product device 150. Event notifications may identify a type of sensor used to detect the event as well as which type of event occurred. Sensors may comprise any component, whether coupled to the device or not, that provides information about the conditions obtaining in and/or around the product device. Sensors may comprise, for example, a humidity sensor, a temperature sensor, a gyroscope, a shock sensor, a voltage sensor, a global positioning system, and a current sensor

Event notifications may be associated with misuse events, such as occurrences that may cause damage to the product device 150. Any number of misuse event types may be defined, such as operating temperature, bump, shock, impact, electrical conditions (e.g. current and/or voltage), humidity, moisture exposure, incorrect part and/or supply installation, etc. Additionally a warranty grade penalty may be associated with each misuse type. Not all event notifications may be associated with a misuse event. A misuse event may be considered an event that results in a reduction in the warranty grade associated with the product device 150.

Severity levels may also be provided in the event notification and may affect a resulting change in warranty grade. For example, sensor values may be sorted into “normal”, “low severity”, “medium severity”, and/or “high severity”. The low/medium/high designation may be assigned based on an amount of deviation from a normal sensor reading. As one illustration, a “normal” operating temperature may be considered to be a range of 60-85 degrees Fahrenheit. A sensor reading of 85-90 degrees Fahrenheit may be considered a “low” severity misuse event, a reading of 90-100 degrees Fahrenheit may be considered a “medium” severity misuse event, and readings over 100 degrees Fahrenheit may be considered a “high” severity misuse event. These ranges may be adjusted for any product device, and are presented only as an example.

Warranty engine 425 may compute a warranty grade for the device and update the warranty grade in response to determining that the data indicates a misuse event. For example, warranty engine 425 may execute modify warranty grade instructions 125 may modify a warranty grade associated with the product device according to the event notification. For example, the warranty grade may be modified by an amount associated with the event type (e.g., a “drop” type misuse event.) Warranty grades may use a scale defined by the warranty issuer (e.g., the manufacturer of product device 150.) For example purposes, a warranty grade may begin at 100 and have grade deductions applied for each misuse event. For example, an operating environment temperature exceeding a safe temperature threshold may result in a −5 penalty to a warranty grade while a drop event, measured by an accelerometer in product device 150, may result in a −15 penalty to the warranty grade.

In some implementations, modify warranty grade instructions 125 may modify the warranty grade by an amount associated with the severity level. For example, a low severity misuse event may result in a −5 decrease to the warranty grade, a medium severity misuse event may result in a −10 decrease to the warranty grade, and a high severity misuse event may result in a −15 decrease to the warranty grade.

Reporting engine 430 may track a history of the warranty grade for the device, provide a visualization comprising the history of the warranty grade for the device, and provide a suggested warranty level associated with the purchase of a second device. Reporting engine 430 may retain a history of each event notification associated with product device 150 and may generate timeline visualization 200. In some implementations, reporting engine 430 may notify the user of product device 150 of the modified warranty grade after an event notification is received. For example, the user may receive an email or other notification and/or a message may be displayed on product device 150. In some implementations, the notification to the user may comprise timeline visualization 200 identifying a time the event notification associated with the device was received. Such a timeline visualization may indicate each time an event notification associated with the device was received, and may show misuse events and/or non-misuse events.

The suggested warranty level may leverage a history of misuse events associated with a user of product device 150. For example, a user with a history of drop events may receive a suggestion to purchase accidental breakage coverage. Such a suggestion may be accompanied by a timeline visualization showing past drop misuse events.

Although one computing device 310 is depicted in FIG. 3, certain implementations of system 300 may comprise more than one computing device 310. At least one of the computing devices may be employed and arranged, for example, in at least one server bank, computer bank, data center, and/or other arrangements. For example, the computing devices together may include a cloud computing resource, a grid computing resource, and/or any other distributed computing arrangement. Such computing devices may be located in a single installation and/or may be distributed among many different geographical locations.

The disclosed examples may include systems, devices, computer-readable storage media, and methods for document element re-positioning. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

What is claimed is:

1. A non-transitory machine-readable medium storing instructions executable by a processor to:
receive an event notification associated with a product device;
modify a warranty grade associated with the product device according to the event notification;
determine whether the modified warranty grade is below a minimum threshold; and
in response to determining that the modified warranty grade is below a minimum threshold, discontinue a warranty for the product device.

2. The non-transitory machine-readable medium of claim 1, wherein the event notification comprises an event type and a severity level.

3. The non-transitory machine-readable medium of claim 2, wherein the instructions to modify the warranty grade associated with the device comprise instructions to modify the warranty grade by an amount associated with the severity level.

4. The non-transitory machine-readable medium of claim 2, wherein the instructions to modify the warranty grade associated with the device comprise instructions to modify the warranty grade by an amount associated with the event type.

5. The non-transitory machine-readable medium of claim 1, wherein the event notification is generated according to a sensor associated with the product device.

6. The non-transitory machine-readable medium of claim 5, wherein the sensor associated with the product device comprises at least one of: a humidity sensor, a temperature sensor, a gyroscope, a shock sensor, a voltage sensor, and a current sensor.

7. The non-transitory machine-readable medium of claim 1, wherein the instructions to discontinue the warranty for the device further comprise instructions to notify a user of the product device of the discontinuation of the warranty.

8. The non-transitory machine-readable medium of claim 7, wherein the notification to the user comprises a timeline visualization identifying a time the event notification associated with the device was received.

9. The non-transitory machine-readable medium of claim 7, wherein the timeline visualization further comprises a plurality of identified times associated with a plurality of event notifications.

10. The non-transitory machine-readable medium of claim 7, wherein the instructions to modify the warranty grade further comprise instructions to notify the user of the modified warranty grade.

11. A method comprising:
determining whether a misuse event has occurred with respect to a product device;
in response to determining that the misuse event has occurred with respect to the product device, reducing a warranty grade of the product device;
receiving a support request for a product device, wherein the product device is associated with a warranty;
determining whether the warranty grade exceeds a minimum threshold;
in response to determining that the warranty grade exceeds the minimum threshold, providing a response to the support request in accordance with the warranty; and
in response to determining that the warranty grade does not exceed the minimum threshold, denying the support request.

12. The method of claim 11, wherein the misuse event comprises a detection, by a sensor associated with the product device, of an event not in compliance with a requirement of the warranty.

13. The method of claim 11, further comprising, in response to determining that the warranty grade does not exceed the minimum threshold, providing an option for the user to purchase a support extension to the warranty.

14. The method of claim 13, wherein the cost of the support extension is based on a trend of a plurality of misuse events associated with the product device.

15. A system, comprising:
a data collection engine to:
collect data from a plurality of sensors associated with a product device, and
determine whether the data indicates a misuse event;
a warranty engine to:
update a warranty grade associated with the product device in response to determining that the data indicates a misuse event; and
a reporting engine to:
track a history of the warranty grade for the product device,
provide a visualization comprising the history of the warranty grade for the product device, and
provide a suggested warranty level associated with the purchase of a second product device.
